(19) United States
(12) Patent Application Publication
(10) Pub. No.: US 2018/0225421 A1
(43) Pub. Date: Aug. 9, 2018

(54) PERSONALIZED HEALTH TRACKER AND METHOD FOR DESTINATION SELECTION BASED ON TRACKED PERSONALIZED HEALTH INFORMATION

(71) Applicant: INTERNATIONAL BUSINESS MACHINES CORPORATION, ARMONK, NY (US)

(72) Inventors: SWAMINATHAN BALASUBRAMANIAN, TROY, MI (US); THOMAS G. LAWLESS, III, WALLKILL, NY (US); JASON R. MALINOWSKI, BRENTWOOD, TN (US); CHERANELLORE VASUDEVAN, BASTROP, TX (US)

(21) Appl. No.: 15/427,871

(22) Filed: Feb. 8, 2017

(51) Int. Cl. G06F 19/00; G06Q 50/00; G01C 21/36; G01C 21/34

(52) U.S. Cl. CPC G06F 19/3431; G06F 19/3481; G01C 21/3484; G06Q 50/01; G01C 21/362; G06F 19/322

(57) ABSTRACT

A method for providing destination guidance based on health risk information, includes receiving a destination request and searching, based on the request, to get a set of destination candidates. Susceptibility of the first user is identified based on retrieved health condition information of the first user. A second user from the plurality of second users that carries a communicable ailment is identified. Rules are applied to determine whether the communicable ailment represents a health risk to the susceptibility of the first user. When it is determined that the communicable ailment represents a health risk to the susceptibility of the first user, the set of destination candidates is filtered to remove candidates that would bring the first user into proximity with the second user that carries the communicable ailment.

### BACKGROUND

### 1. Technical Field

The present disclosure relates to health tracking, and more particularly, to personalized health trackers and methods for destination selection based on tracked personalized health information.

### 2. Discussion of Related Art

Destination selection and navigation guidance are important technical innovations. Users may use smartphones or automobile navigation devices to select a desired destination and be guided to that destination with turn-by-turn directions. Where once such systems prompted user to enter the exact address of their destination, and then computed routes of travel according to such factors as shortest distance, road speed limits, and tool avoidance, modern systems are able to help a user determine a destination and to compute routes of travel according to various real-time factors such as actual traffic patterns.

U.S. patent application Ser. No. 15/175,720, filed on Jun. 7, 2016, the contents of which is hereby incorporated by reference in its entirety, introduces the concept of destination selection and navigation guidance based on avoiding persons with various communicable ailments, using wearable devices. However, these approaches nay be overly protective as not all people are equally susceptible to all ailments.

### BRIEF SUMMARY

A method for providing destination guidance based on health risk information, includes receiving destination request. A destination is searched for based on the destination request and receiving a plurality of destination candidates as a result of the search. Health condition information of a first user is retrieved. A susceptibility of the first user is identified based on the retrieved health condition information of the first user. Health condition information from a plurality of second users is retrieved. A second user, from the plurality of second users that carries a communicable ailment, is identified. One or more rules is applied to determine whether the communicable ailment represents a health risk to the susceptibility of the first user. When it is determined that the communicable ailment represents a health risk to the susceptibility of the first user, the plurality of destination candidates is filtered to remove destination candidates therefrom that would bring the first user into proximity with the second user that carries the communicable ailment.

A computer program product provides destination guidance based on health risk information. The computer program product includes a computer readable storage medium having program instructions embodied therewith. The program instructions are executable by a computer to cause the computer to receive, by the computer, a destination request. A destination is searched for based on the destination request. A plurality of destination candidates is received as a result of the search. Health condition information of a first user or a person in likely contact with the first user is received. A susceptibility of the first user, or the person in likely contact with the first user, is determined based on the retrieved health condition information of the first user, or the person in likely contact with the first user. Health condition information from a plurality of second users is received. A second user from the plurality of second users that carries a communicable ailment is identified. One or more rules are applied to determine whether the communicable ailment represents a health risk to the susceptibility of the first user, or the person in likely contact with the first user. When it is determined that the communicable ailment represents a health risk to the susceptibility of the first user, or the person in likely contact with the first user, the plurality of destination candidates is filtered, by the computer, to remove destination candidates therefrom that would bring the first user into proximity with the second user that carries the communicable ailment.

A system for providing destination guidance based on health risk information includes a mobile computer device for interacting with a server, over the Internet. The server is configured to receive a destination request. A destination is searched for based on the destination request. A plurality of destination candidates is received as a result of the search. Health condition information of a first user is retrieved. A susceptibility of the first user is identified based on the retrieved health condition information of the first user. Health condition information from a plurality of second users is retrieved. A second user from the plurality of second users that carries a communicable ailment is identified. One or more rules are applied to determine whether the communicable ailment represents a health risk to the susceptibility of the first user. The plurality of destination candidates is filtered to remove destination candidates therefrom that would bring the first user into proximity with the second user that carries the communicable ailment when it is determined that the communicable ailment represents a health risk to the susceptibility of the first user.

A method for providing destination guidance based on health risk information, includes retrieving a health condition information of a first user. A susceptibility of the first user is identified based on the retrieved health condition information of the first user. A present location of the first user is received. Health condition information from a plurality of second users who are or were recently located in a vicinity of the received present location is received. A second user is identified from the plurality of second users that carries a communicable ailment. One or more rules is applied to determine whether the communicable ailment represents a health risk to the susceptibility of the first user. When it is determined that the communicable ailment represents a health risk to the susceptibility of the first user, an alert is generated to inform the first user of the health risk.

### BRIEF DESCRIPTION OF THE SEVERAL VIEWS OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a schematic diagram illustrating an arrangement for tracking real-time ambient health conditions and providing destination selection assistance and route guidance in accordance with exemplary embodiments of the present invention;

FIG. 2 is a schematic diagram illustrating data handling and destination selection assistance in accordance with exemplary embodiments of the present invention;

FIG. 3 is a flow chart illustrating an approach for tracking real-time ambient health conditions and providing destination selection assistance/route guidance in accordance with exemplary embodiments of the present invention;

FIG. 4 is a flow chart illustrating a detailed view for performing navigation assistance in accordance with an exemplary embodiment of the present invention;

FIG. 5 is a flow chart illustrating a detailed view for performing location guidance in accordance with an exemplary embodiment of the present invention; and

FIG. 6 shows an example of a computer system capable of implementing the method and apparatus according to exemplary embodiments of the present disclosure.

### DETAILED DESCRIPTION

In describing exemplary embodiments of the present disclosure illustrated in the drawings, specific terminology is employed for sake of clarity. However, the present disclosure is not intended to be limited to the specific terminology so selected, and it is to be understood that each specific element includes all technical equivalents which operate in a similar manner.

Exemplary embodiments of the present invention provide destination selection and navigation guidance based on personalized health risk information so that a first user may avoid exposure to second users who may be carrying a particular ailment that the first user may be particularly susceptible to and/or to avoid exposure to second users who may be carrying a particular ailment that someone who the first user comes into contact with may be particularly susceptible to. Moreover, in providing the destination selection and navigation guidance, consideration is given to the particular ailment being carried by the second users and the nature of the susceptibility of the first user so that an appropriate level of avoidance, with respect to both time and space, may be selected so that risk of communication of the ailment may be minimized without being overly protective, as overprotection may lead to needless inconvenience.

Exemplary embodiments of the present invention may utilize a rules-based approach for determining which ailments of second users are a particular risk to a given first user and the people the first user is exposed to. A set of rules may be maintained, for example, in a rules database and the rules database may be indexed and quickly referenced at the time that the first user seeks destination selection.

In addition to maintaining a rules database, exemplary embodiments of the present invention may also utilize a medical records database which may store medical records pertaining to the first user and the set of second users. The medical records database may include actual electronic medical records associated with the healthcare of each user; however, the medical records database may also include, for each user, a health table indicating communicable ailments and susceptibilities/vulnerabilities. The medical records database may include such health tables for the first user, the set of second users, and additionally those people the first user shares close proximity to, such as family, friends and people who the first user may come into contact with in the work environment.

The establishment of these health tables, and the updating thereof, may be performed periodically, or continuously as part of an off-line process, which is to say, it need not occur in real-time at the time of destination selection assistance. These tables may be established/updated either manually, for example, by the user or the user's health care professional, or algorithmically, for example, based on data found within the actual electronic medical records. In this way, at the point of destination selection assistance, the various heath tables may be quickly pulled up so as to be applied to the rules of the rules database.

The health tables may include, for each communicable ailment and susceptibility/vulnerability, a score indicating a quantification of just how communicable the user is to others, for the particular ailment, or just how susceptible/vulnerable the user is to each particular ailment.

The health tables may include health risk profile, in which fitness data, medical data, family data, and geo-social data is entered, along with the aforementioned communicable ailment and susceptibility/vulnerability information. The fitness data may include data obtained by wearable devices, such as heart rate, steps taken, etc. This information may be mapped to a fitness level score, which would indicate a general level of fitness of the user. The medical data may include a date of the last performed physical examination, blood test results, recent illnesses, etc. The family data may include information pertaining to the user's family connections. This information may be manually provided or determined/inferred by examining social media accounts. Geo-social data may include information as to who the user is most likely to come into contact with in a day-to-day basis and what susceptibilities those people may be likely to have.

The rules of the rules database may include logic for determining whether a particular ailment of a second user, given its score, poses a risk to a particular susceptibility/vulnerability of a first user (or personal contact), given its score. Thus, the rules of the rules database may make use of various thresholds, which may be used to provide a quick determination as to whether avoidance is needed during destination selection.

As discussed above, health information may be manually provided, inferred from social media sources, or monitored by one or more wearable devices. In this way, monitored health condition information may be used to identify a person with a medical susceptibility and one or more people with an ailment that the person with the medical susceptibility may be particularly vulnerable to.

While wearable devices most commonly measure steps taken, heartrate, blood pressure, blood oxygen, and various other properties, exemplary embodiments of the present invention contemplate the use of wearable devices for monitoring various other measures of health not commonly in use within wearable devices at this time, and accordingly, exemplary embodiments of the present invention may well be able to make use of any available health information that can be provided by a wearable device, such as the presence of and measure of various antibodies within the user's blood that may establish resistances and susceptibilities to various types of infections.

The rules of the rules database may be programmed to take into account whether the first user, or the people the first user is likely to come into contact with are immunocompromised, and if so, what sorts of ailments, and to what extent are they vulnerable. The rules will compare this information to information pertaining to a group of second users, who have agreed to participate in the system described herein. It is to be understood that the second users may themselves be first users at various times.

The second users may be patients carrying a communicable disease that may threaten the health of the immunocompromised patient. The first user may alternatively be a pregnant woman, a newborn baby, or an elderly patient and the second users may be patients carrying a communicable disease that is particularly dangerous to a pregnant woman, a newborn baby, or an elderly patient. Alternatively, the first user may be a patient with a severe food allergy and the second users may be people carrying or consuming the allergen food.

When the rules are used to make a match between a first user and one or more second users, exemplary embodiments of the present invention may use the location and route data, acquired by the wearable device and/or smartphones, to track the location and route of the user and participants.

As described herein, location may indicate the global coordinates of the person in question and route data may include a set of past locations with respect to time (e.g. the path recently taken by the person) as well as a predicted future course of movement, which is derived from the person's trajectory, past movements, and/or, where the person is in the process of using navigation assistance, for example, implemented on the person's smartphone, the programed destination and selected route.

By examining the location and routes of the user as well as the participants, exemplary embodiments of the present invention may be used to issue avoidance alerts to the first user and may also interface directly with the user's smartphone-implemented navigation guidance in such a way as to help the user to select alternative routes and/or alternative destinations so as to avoid crossing paths with the participants within some period of time (“time buffer”) that is calculated according to the nature of the communicability of the disease (e.g. whether the disease is airborne, spread by fluid, or spread by direct contact) and how long the given disease is able to maintain communicability. For example, a disease that is spread only by direct contact may lead to a relatively small time buffer, which is to say, the first user may be warned/guided to prevent them being at the same place at the same time, while for a disease that is spread by fluids, there may be a relatively long buffer time, which is to say, the first user may he warned/guided to prevent them from being at a place that the second user has been in some number of minutes, hours, or days ago.

As mentioned above, destination selection is one way in which exemplary embodiments of the present invention may help the first user avoid crossing paths with the matched second users. According to this approach, the first user would use a smartphone to find a destination, for example, a coffee shop, and the user may be presented with a selection of destinations that matched second are not at, have not been to, and/or are not on their way to. This feature is described herein as “destination selection assistance.”

In this way, exemplary embodiments of the present invention may be used to augment smartphone or automobile-implemented navigation guidance by taking into account health condition data that is tracked by wearable devices utilized by a group of second users whose location and route is tracked. The health and safety of the first user may therefore be protected.

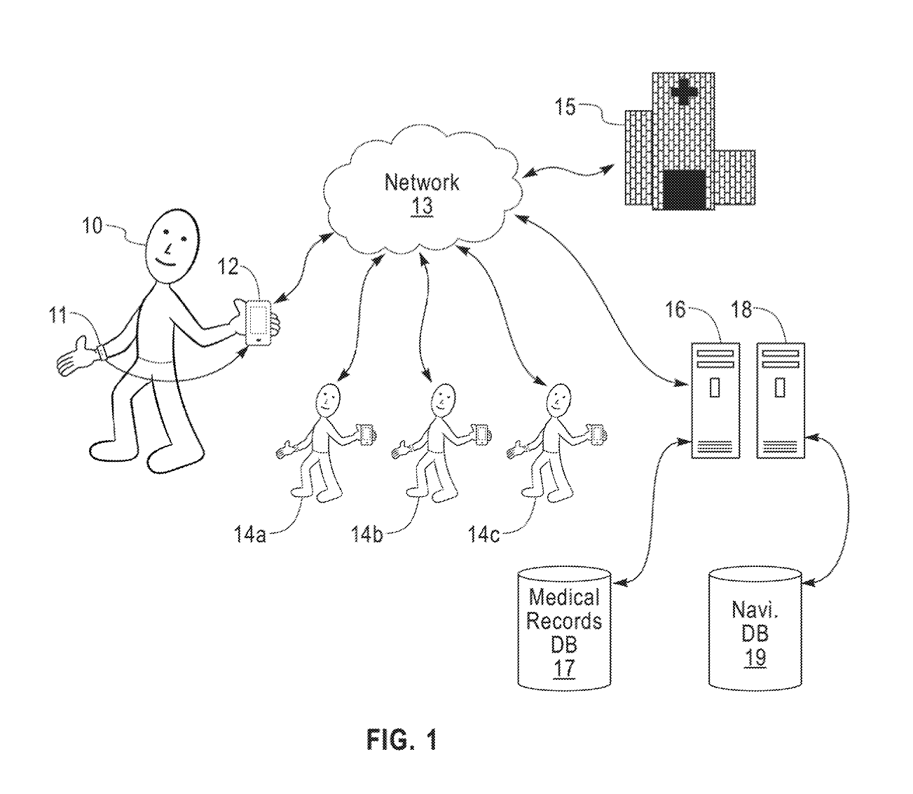

FIG. 1 is a schematic diagram illustrating an arrangement for tracking real-time ambient health conditions and providing destination selection assistance and route guidance in accordance with exemplary embodiments of the present invention. A first user 10 may carry a wearable device 11 such as a fitness tracker or smartwatch. An example of a fitness tracker is FITBIT sold by FITBIT INC. and an example of a smartwatch is APPLE WATCH sold by APPLE INC., however, other products are commercially available.

The wearable device 11 may include one or more health and movement sensors for monitoring the health condition of the user 10. Examples of health sensors may include heart rate monitor, blood glucose sensor, thermocouple, blood oxygen sensor, blood cholesterol sensor, blood antibody detector, etc. and examples of movement sensors include an accelerometer, a step counter, a compass, GPS, etc.

The user may also carry a smartphone 12, which may receive data from the wearable device 11, for example, wirelessly using communications standards such as Bluetooth low energy (BTLE), designed and marketed by the BLUETOOTH SPECIAL INTEREST GROUP.

The smartphone 12 may be configured for providing navigation guidance as well as health and location monitoring as described herein. The smartphone 12 may be equipped with a touch-sensitive display for handling I/O, a BLUETOOTH radio for communicating with the wearable device 11, a GPS radio for aiding in navigation guidance, and a CPU for performing the processing functions described herein.

The smartphone 12 may be in communication with a central server 16 over a wide-area computer network 13 such as the Internet. The smartphone 12 may include a cellular radio for maintaining this connection. The cellular radio may be, for example, an LTE radio, however, other forms of cellular radio may be included.

The smartphone 12 may have one or more application and core functions installed thereon for the performance of the steps described below, for interacting with the central server 16, and for providing navigation guidance.

The central server 16 may be embodied as a single physical host machine, a cluster of host machines, a distributed set of host machines, one or more virtual machines running on one or more physical hosts, or as some other computational construct. The central server 16 may also be in communication with a medical records database 17 that stores medical records for the user and a group of second users 14a, 14b, 14c, for example, over the network 13. The central server 16 may also be in communication with a healthcare institution 15 such as a clinic, hospital, research facility, etc. The healthcare institution 15 may maintain electronic medical records for the first users, second users, and people in likely contact with the first users. It is to be understood that these records may be separately maintained, but for the purposes of this disclosure, it may be assumed that the single healthcare institution 15 maintains all medical records.

Moreover, the aforementioned health tables may be generated, for example, from the electronic medical records, and then stored in the medical records database 17. While the electronic medical records may include a wide variety of health data, the health table may include only that data pertinent to first user/second exposure prevention necessity.

The second users 14a, 14b, and 14c may similarly be outfitted with wearable devices and smartphones.

As described above, destination selection assistance is performed based on the health tables for the first user, the second users, and the people in likely contact with the first user. Destination selection assistance may be performed by a navigation server 18, based also in a navigation database 19, which may include destinations by name, type and location, as well as a full maps database. Rather than maintaining an independent navigation database 19, exemplary embodiments of the present invention may interface with an existing maps service, such as GOOGLE MAPS maintained by GOOGLE, for which open APIs are readily available.

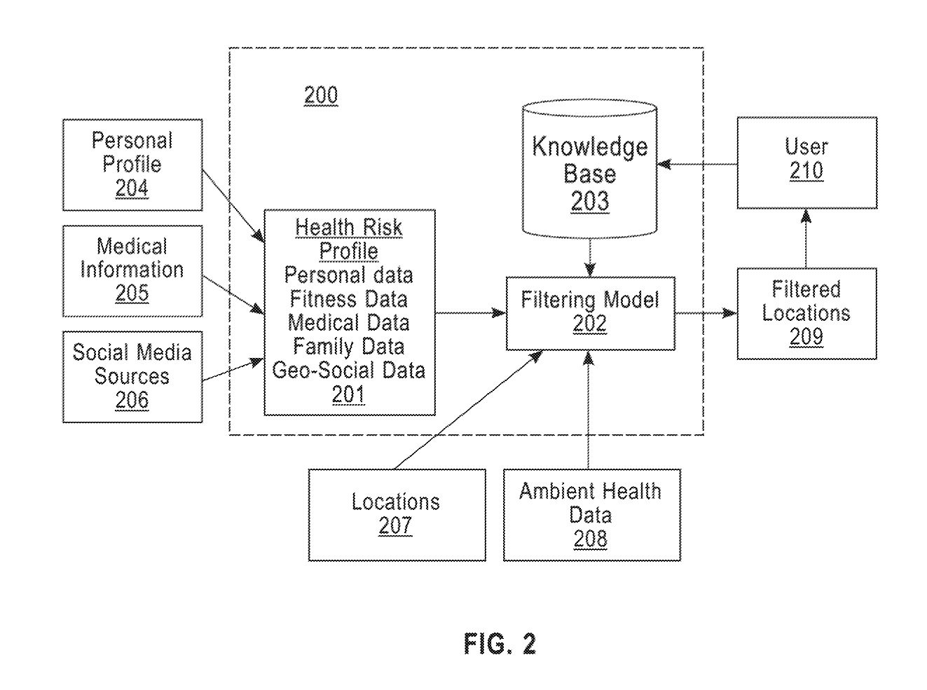

FIG. 2 is a schematic diagram illustrating data handling and destination selection assistance in accordance with exemplary embodiments of the present invention. The system for performing destination selection 200 may make use of health risk profiles 201 for the first user, each second user, and those in likely contact with the first user. The health risk profile may include the concept of the health table discussed above, but may also include additional data. For example, the health risk profile may include, for each person, personal data such as a unique system account number (as sensitive information may be anonymized), fitness data, medical data (e.g. health table), family data, and geo-social data (the family data and geo-social data may be used to determine the set of people in likely contact with the first user).

The health risk profile 201 may be generated by examining personal profiles for users 204, medical information for the users (e.g. electronic medical records), and various social media sources 206, which may be used to infer the family data and/or geo-social data. Geo-social data may also include what locations the user resides in, works in, and generally travels to.

The health risk profiles 201, so constructed, may be used by a filtering model 202, for example, at the time of destination selection assistance, to help filter down from a list of all possible destinations down to one or a few possible destinations based on the application of the health risk profile 201 to the rules (for example, as described above), which may reside in a knowledge base 203. The set of one or a few possible destinations may be outputted as a set of filtered locations 209 which may then be provided to the first user 210. The first user 210 may also provide feedback to the knowledge base 203 for improving subsequent destination selection assistances.

In making its determination, the filtering model may also look to the present location of the first user, second users, and likely contacts of the first user 207, as well as ambient health data 208, which may include information pertaining to which second users are present at which locations at the instant time.

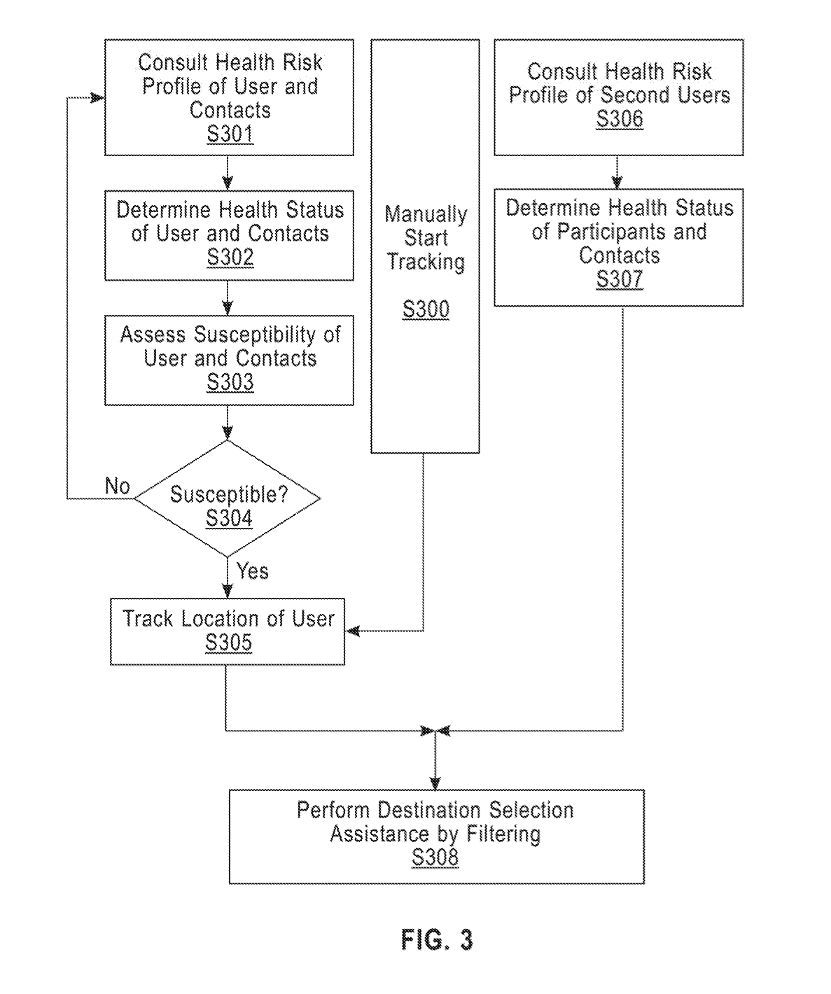

FIG. 3 is a flow chart illustrating an approach for tracking real-time ambient health conditions and providing destination selection assistance/route guidance in accordance with exemplary embodiments of the present invention. As described above, health risk profiles, for example, the health tables, may be consulted, along with the wearable-tracked health data (Step S301). Based on this tracked health data, medical records for the user retrieved from the medical records database 17, and/or user input, a health status of the first user may be determined (Step S302). In this context, health status is defined as information pertaining to whether the user 10 is particularly susceptible to one or more diseases. If the user is determined not to be susceptible (No, Step S304), then the process may end or the steps S301-S303 may be periodically repeated unless and until the user is determined to be susceptible (Yes, Step 304).

In determining whether the first user is particularly susceptible, the susceptibility of the first user's likely contacts may also be considered. In this regard, the susceptibility of the likely contacts of the first user may be considered as the susceptibility of the first user. For example, where the first user is a care giver to a patient, the susceptibility of the patient may be considered, for these purposes, to be a susceptibility of the first user.

When it is determined that the user is susceptible (Yes, Step S304), the location and route of the user is tracked, for example, using the wearable device 11 and/or the smartphone 12 (Step S305).

According to some exemplary embodiments of the present invention, there need not be any estimation as to whether the user is susceptible to a particular disease condition. Exemplary embodiments of the present invention may be used, for example, by parents wishing to protect their children, or by caregivers wishing to protect the elderly from diseases, generally. Accordingly, steps S301-S304 may be optionally omitted in such a use case. Rather, the user may simply select tracking to begin (Step S300).

Meanwhile, health risk profiles for the second users may be similarly considered (Step S306) and the health status of the second users may accordingly be determined (Step S307). The risk to the first user and likely contacts, based on this information may then be assessed (Step S308), for example, by applying the rules to the health tables, as described in detail above.

Steps S306 and S307 may be periodically performed, or they need not be performed unless and until deamination selection assistance is requested. However, when requested, destination selection assistance may be performed (Step S308) by filtering a set of candidate destinations, for example, as acquired by the map service, so as to avoid potential contact between the first user and second users who represent a particular risk to the health of the first user or the people in likely contact with the first user.

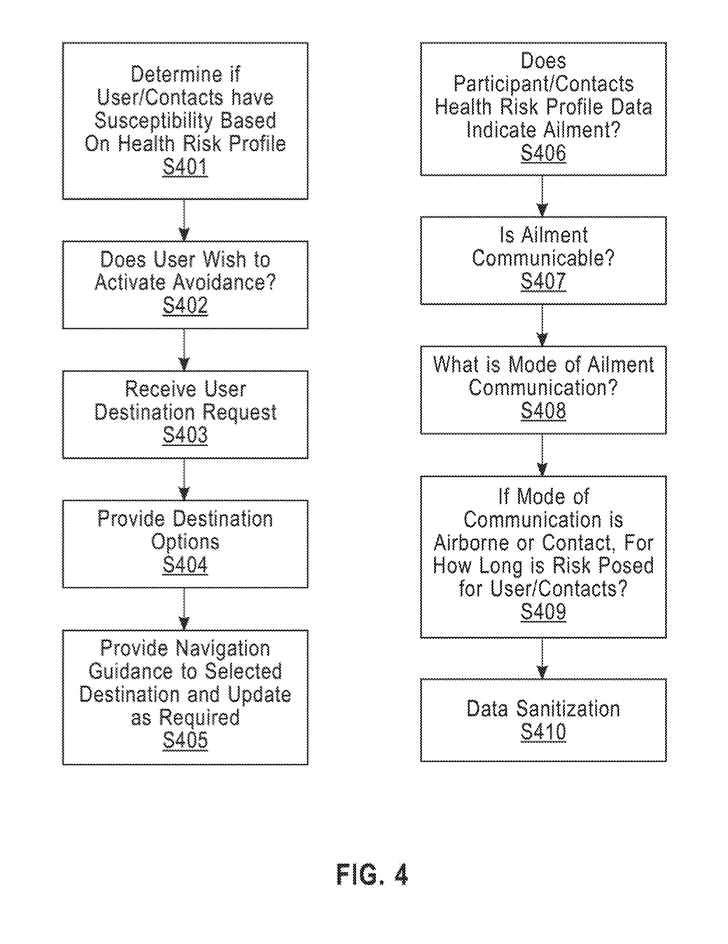

As discussed above, in tracking real-time ambient health conditions according to exemplary embodiments of the present invention, the susceptibility of the user is assessed (Step S303) and the risk posed to the user by the health condition of the participants is assessed (Step S308). FIG. 4 is a flow chart illustrating a detailed view of these steps in accordance with an exemplary embodiment of the present invention.

In assessing the susceptibility of the user, it may be determined whether the tracked fitness/health data, the medical records, and/or user-provided data are indicative of an ailment or condition that would (Step S401). In one simple example, the medial records may explicitly provide that the first user has such a condition, or in another simple example, the user may identify him or herself as having such a condition, for example, by an input made to an application installed on the first user's smartphone.

According to more complex examples, the tracked fitness/health data may be suggestive of such an ailment or condition and the user and/or the first user's health care provider/institution 15 may be queried to confirm or reject the suggestion.

This determination may be made locally by the application running on the first user's smartphone 12, or remotely via the network 13, for example, by the central server 16.

Where the first user has been determined to be susceptible, the first user may be prompted to indicate whether be or she wishes to activate the avoidance feature of the smartphone application, or the first user may independently invoke the avoidance feature (Step S402). By invoking the avoidance feature, the first user is expressing a willingness to have ambient health conditions tracked and/or to have destination selection aided in accordance with ambient health conditions.

Where the first user invokes ambient health conditions tracking, an area map may be displayed with locations and routes of high-risk participants highlighted. Where the first user invokes destination selection assistance, the first user may be prompted to provide a destination request, for example, to input where or what sort of establishment the first user wishes to travel to. After the user destination request is received (Step S403), a set of destination options may be provided to the user (Step S404). For example, where the destination request is a coffee house, a set of nearby coffee houses may be displayed, with those coffee houses that coincide with the location or route of high-risk participants being first filtered out, for example, using the filter model, as described in detail above.

According to some exemplary embodiments of the present invention, the user may be prevented from receiving a display with locations and routes of high-risk participants highlighted thereon, and instead, the user might be restricted to destination options. In this way, the exact location of the high-risk participants may be made inaccessible to the user, and so the participants may feel a greater willingness to participate in the system knowing that their location and route cannot be directly observed by others.

Thereafter, the first user may select from among the list of the restricted destination options and navigation guidance may be provided (Step S405), for example, again using an available mapping service. It may happen that none of the possible destination locations represent an ambient health risk, and in such a case, all destination candidates may be provided to the user, or the results may be filtered according to conventional criteria, such as proximity, rating, etc. According to an exemplary embodiment of the present invention, the first user might not be able to determine for sure whether one or more possible destination locations have been removed.

In assessing the risk posed by a given second user to the first user, first it may be determined if the second user has an ailment that could be a risk to the user. This may be performed, for example, using the tracked health/activity data, medical records, health tables, and/or participant-provided data (Step S406). This step is similar in many ways to step S401 discussed above. In making this determination, patient medical records or an encyclopedia of medical knowledge may be referenced. Thus, the present approach may be able to make use of a medical knowledgebase without the need for records of a specific user (e.g. patent), however, where such individualized records are available, they may be used. The encyclopedia of medical knowledge may be embodied, for example, as a table defining which ailments represent a high risk to which patient-susceptibilities.

The encyclopedia of medical knowledge may determine not only if the ailment of the participant is a risk to the user, but also, whether the ailment is communicable (Step S407), and if so, how it is transmitted (Step S408). For example, possible vectors of transmission may include airborne transmission, contact transmission, or fluid transmission, and may further be used to determine how long a location represents a risk to the user, after the participant has left a given location, as some pathogens have a better ability to survive in the air and on surfaces than other pathogens (Step S409).

The results of these determinations may be stripped of all identifying data so the identity of the individual participants is not revealed (Step S410). For example, as discussed above, the user might only see that some locations or destination options are highlighted as risky for as long as it is calculated that the risk of exposure and/or transmission lingers, and the user might not be able to see who the participants are, where the participants are, or what ailments they have.

The user and participants may interact with the above-described system using a mobile application installed on their respective smart phones. The mobile applications may pass interactions to the central server, which may be responsible for performing the above-described analysis. However, where available computational power is present in the aforementioned smartphones, some processing may be performed locally, with the exception that sensitive information concerning the participants is never passed to the user's smartphone for processing.

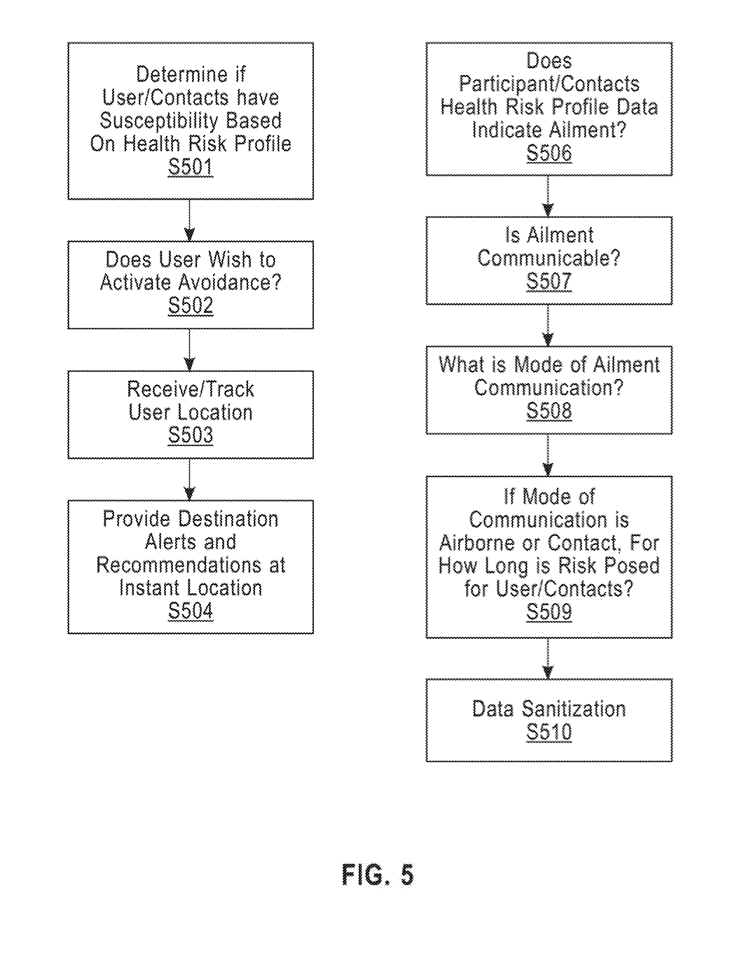

According to some exemplary embodiments of the present invention, rather than using the above-described approach for performing location guidance that avoids health risks, exemplary embodiments of the present invention may be used to receive and/or track the location of the user and to alert the user to potential health risks in the immediate vicinity of the user's location so that the user may better avoid heath risks in the areas where the user chooses to visit. FIG. 5 is a flow chart illustrating a detailed view for performing location guidance in accordance with an exemplary embodiment of the present invention.

As explained above, first it may be determined whether the user or those people that the user is likely to come into immediate contact with have a particular susceptibility (Step S501). This determination may be made, for example, based on the health risk profile for the user and the contacts. The user may indicate, at Step S502, whether active avoidance is desired. Where active avoidance is desired, the user's location may be monitored or tracked (Step S503). The location of the user may be monitored by the user affirmatively sending the user's location when the user desires to have that location checked for potential health risks, or the location of the user may be tracked by the user's location being continuously or periodically sent so that it may be determined when the user is in motion or at rest, and when the user is determined to be at rest, the user's location is automatically checked for nearby health risks.

In either case, the user's location may be checked for potential health risks in the immediate vicinity, for example, in a manner similar to that discussed above, and when there is indeed a potential health risk identified in the immediate vicinity, an alert is generated and sent to the user to describe the nature of the health risk (Step S504). The alert may, for example, tell the user that certain establishments at the immediate vicinity represent a health risk and should be avoided. The alert may also provide recommendations as to what establishments at the immediate vicinity may be safely visited.

While the approach for monitoring health risks shown in FIG. 5 differs from the approach described above with respect to FIG. 4, the procedure for identifying health risks posed by the participants is substantially similar. As was described above, it is determined for each participant, whether health risk profile data indicates an ailment (Step S506). If the ailment is determined to be communicable (Step S507), the mode of communication is ascertained (Step S508). If the mode of communication is airborne or transmission-by-contact, the length of time the risk is likely to persist is determined (Step S509). The data is sanitized (Step S510) and then the sanitized data is ready to be used in providing, destination alerts at the user's instant location (Step S504).

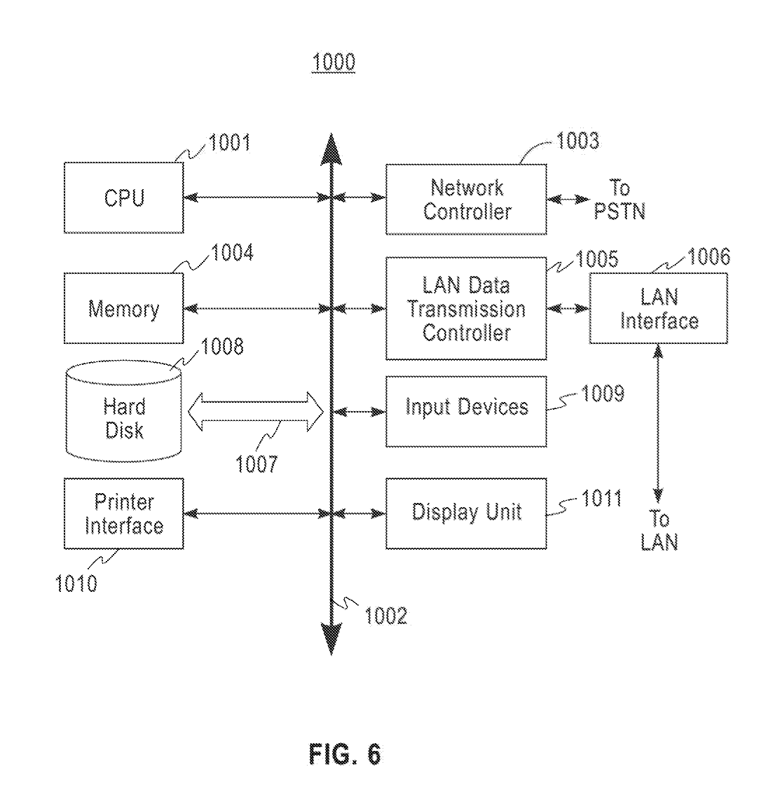

FIG. 6 shows an example of a computer system which may implement a method and system of the present disclosure. The system and method of the present disclosure may be implemented in the form of a software application running on a computer system, for example, a mainframe, personal computer (PC), handheld computer, server, etc. The software application may be stored on a recording media locally accessible by the computer system and accessible via a hard wired or wireless connection to a network, for example, a local area network, or the Internet.

The computer system referred to generally as system 1000 may include, for example, a central processing unit (CPU) 1001, random access memory (RAM) 1004, a printer interface 1010, a display unit 1011, a local area network (LAN) data transmission controller 1005, a LAN interface 1006, a network controller 1003, an internal bus 1002, and one or more input devices 1009, for example, a keyboard, mouse etc. As shown, the system 1000 may be connected to a data storage device, for example, a hard disk, 1008 via a link 1007.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon,

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Exemplary embodiments described herein are illustrative, and many variations can be introduced without departing from the spirit of the disclosure or from the scope of the appended claims. For example, elements and/or features of different exemplary embodiments may be combined with each other and/or substituted for each other within the scope of this disclosure and appended claims.

What is claimed is:

1. A method for providing destination guidance based on health risk information, comprising:
receiving destination request;
searching for a destination based on the destination request and receiving a plurality of destination candidates as a result of the search;
retrieving a health condition information of a first user;
identifying a susceptibility of the first user based on the retrieved health condition information of the first user;
retrieving health condition information from a plurality of second users;
identifying a second user from the plurality of second users that carries a communicable ailment;
applying one or more rules to determine whether the communicable ailment represents a health risk to the susceptibility of the first user; and
when it is determined that the communicable ailment represents a health risk to the susceptibility of the first user, the plurality of destination candidates is filtered to remove destination candidates therefrom that would bring the first user into proximity with the second user that carries the communicable ailment.

2. The method of claim 1, wherein the destination request is received from the first user.

3. The method of claim 1, wherein the health condition information retrieved for the first user includes: personal data, fitness data, medical data, family data, or geo-social data.

4. The method of claim 3, wherein the fitness data is retrieved from a wearable health tracker device or a smartwatch.

5. The method of claim 3, wherein the medical data is retrieved from electronic medical records.

6. The method of claim 3, wherein the geo-social data is retrieved from one or more social media sources.

7. The method of claim 1, wherein a susceptibility of the first user includes a susceptibility of a person in likely contact with the first user.

8. The method of claim 7, wherein the person in likely contact with the first user is identified from one or more social media sources,

9. The method of claim 1, wherein the one or more rules that are used to determine whether the communicable ailment represents a health risk to the susceptibility of the first user are based on information from a medical knowledge database and include a table of possible medical ailments and characteristics of corresponding patients having an elevated risk of catching each medical ailment.

10. The method of claim 1, further comprising:
receiving a selection from the first user indicating a desired destination from the filtered plurality of destination candidates; and
providing navigation guidance to assist the first user in reaching the desired destination.

11. The method of claim 1, wherein the one or more rules includes a decision table defining relationships between various susceptibilities and various communicable ailments.

12. The method of claim 11, wherein the decision table is manually constructed from medical knowledge and then iterated from feedback of the first user.

13. A computer program product for providing destination guidance based on health risk information, the computer program product comprising a computer readable storage medium having program instructions embodied therewith, the program instructions executable by a computer to cause the computer to:
receive, by the computer, a destination request;
search, by the computer, for a destination based on the destination request and receive, by the computer, a plurality of destination candidates as a result of the search;
retrieve, by the computer, health condition information of a first user or a person in likely contact with the first user;
identify, by the computer, a susceptibility of the first user, or the person in likely contact with the first user, based on the retrieved health condition information of the first user, or the person in likely contact with the first user;
retrieve, by the computer, health condition information from a plurality of second users;
identify, by the computer, a second user from the plurality of second users that carries a communicable ailment;
apply, by the computer, one or more rules to determine whether the communicable ailment represents a health risk to the susceptibility of the first user, or the person in likely contact with the first user; and
when it is determined that the communicable ailment represents a health risk to the susceptibility of the first user, or the person in likely contact with the first user, the plurality of destination candidates is filtered, by the computer, to remove destination candidates therefrom that would bring the first user into proximity with the second user that carries the communicable ailment.

14. The computer system of claim 13, wherein the health condition information retrieved for the first user includes: personal data, fitness data, medical data, family data, or geo-social data.

15. A system for providing destination guidance based on health risk information, comprising:
a mobile computer device for interacting with a server, over the Internet, the server configured to:
receive a destination request;
search for a destination based on the destination request and receive a plurality of destination candidates as a result of the search;
retrieve a health condition information of a first user;
identify a susceptibility of the first user based on the retrieved health condition information of the first user;
retrieve health condition information from a plurality of second users;
identify a second user from the plurality of second users that carries a communicable ailment;
apply one or more rules to determine whether the communicable ailment represents a health risk to the susceptibility of the first user; and
filter the plurality of destination candidates to remove destination candidates therefrom that would bring the first user into proximity with the second user that carries the communicable ailment, when it is determined that the communicable ailment represents a health risk to the susceptibility of the first user.

16. The system of claim 15, wherein the mobile device is configured to receive the destination request from the first user.

17. The system of claim 16, wherein the health condition information retrieved for the first user includes fitness data, and: personal data, medical data, family data, or geo-social data, and the fitness data is retrieved from a wearable health tracker device or a smartwatch.

18. A method for providing destination guidance based on health risk information, comprising:
retrieving a health condition information of a first user;
identifying a susceptibility of the first user based on the retrieved health condition information of the first user;
receiving a present location of the first user;
retrieving health condition information from a plurality of second users who are or were recently located in a vicinity of the received present location;
identifying a second user from the plurality of second users that carries a communicable ailment;
applying one or more rules to determine whether the communicable ailment represents a health risk to the susceptibility of the first user; and
when it is determined that the communicable ailment represents a health risk to the susceptibility of the first user, generating an alert to inform the first user of the health risk.

19. The method of claim 18, wherein the generated alert includes one or more destinations to avoid within the vicinity of the present location.

20. The method of claim 18, wherein the generated alert includes one or more destinations that are safe within the vicinity of the present location.

21. The method of claim 18, wherein the health condition information retrieved for the first user includes: personal data, fitness data, medical data, family data, or geo-social data.

22. The method of claim 21, wherein the fitness data is retrieved from a wearable health tracker device or a smartwatch.

23. The method of claim 21, wherein the medical data is retrieved from electronic medical records.

24. The method of claim 21, wherein the geo-social data is retrieved from one or more social media sources.

25. The method of claim 18, wherein a susceptibility of the first user includes a susceptibility of a person in likely contact with the first user.

26. The method of claim 25, wherein the person in likely contact with the first user is identified from one or more social media sources.

27. The method of claim 18, wherein the one or more rules that are used to determine whether the communicable ailment represents a health risk to the susceptibility of the first user are based on information from a medical knowledge database and include a table of possible medical ailments and characteristics of corresponding patients having an elevated risk of catching each medical ailment.

28. The method of claim 18, wherein the one or more rules includes a decision table defining relationships between various susceptibilities and various communicable ailments.

29. The method of claim 28, wherein the decision table is manually constructed from medical knowledge and then iterated from feedback of the first user.
